(19) United States
(12) Patent Application Publication
(10) Pub. No.: US 2007/0182245 A1
(43) Pub. Date: Aug. 9, 2007

(54) Hydraulic braking system that provides acceleration assistance and battery recharging

(76) Inventor: Leonard A. DuCharme, American Fork, UT (US)

Correspondence Address: Leonard A. DuCharme, 892 North 340 East, American Fork, UT, 84003, US

(21) Appl. No.: 11/637,299

(22) Filed: Dec. 12, 2006

Related U.S. Application Data
(60) Provisional application No. 60/748,934, filed on Dec. 12, 2005.

(51) Int. Cl. B60T 8/64

(52) U.S. Cl. 303/152

(57) ABSTRACT

The invention is a hydraulic braking system that captures an electric/hybrid vehicle's kinetic energy and utilizes it to assist in accelerating the vehicle or to recharge the vehicle's battery pack.

### PRIORITY CLAIM

The present application claims the benefit of U.S. Provisional patent application Ser. No. 60/748,934, filed Dec. 12, 2005, and entitled HYDRAULIC REGENERATIVE BRAKING SYSTEM THAT PROVIDES ACCELERATION ASSISTANCE AND BATTERY RECHARGING.

### BACKGROUND

1. Field of the Invention

The present invention relates generally to hydraulic braking systems for vehicles. More particularly, the present invention relates to a design for a hydraulic braking system that captures an electric/hybrid vehicle's kinetic energy during the braking process, stores the energy as pressure in an hydraulic accumulator(s), and utilizes the pressure to drive an electric generator, which in turn, recharges the vehicle's battery pack, or, alternatively, uses the stored energy to assist in the acceleration of the vehicle.

The purpose of the invention is to provide a braking system that will capture a vehicle's kinetic energy during the braking process, rather than expend it as heat generated by friction. Key components in the system are hydraulic pumps, a reservoir, hydraulic accumulators, a hydraulic motor, continuously variable transmissions, magnetic clutches, and an electricity generator. Depending on the type of vehicle in question, a pump assembly may be affixed to the drive axle for each wheel. In other types of vehicles, it may be more practical to utilize a larger pump assembly for a set of drive wheels.

2. Related Art

A moving vehicle has considerable kinetic energy, depending on the size and velocity of the vehicle. In conventional vehicles, this kinetic energy is lost during the braking process: friction is applied via brake pads and rotors causing the vehicle to slow. Given the relative, escalating cost of energy, wasting a vehicle's kinetic energy is no longer practical.

Regenerative braking systems are now being used in electric and hybrid vehicles to recapture kinetic energy. Generally, these types of systems involve utilizing the rotation of the wheels to turn generators, a portion of the energy from which is used to recharge the vehicle's batteries. However, these types of systems fail to utilize much of the kinetic energy, primarily because battery storage systems frequently used in electric and hybrid vehicles can't store the amperage at the rate at which it is generated. In other words, a 2,000 lb vehicle traveling at 50 mph could generate hundreds of amps during the braking cycle. However, the vehicle's battery may not be able to take more than, say, 50 amps as a recharging current. Consequently, much of the amperage generated during the braking process is lost.

Another more promising type of regenerative braking system utilizes hydraulics. One such experimental system was developed by Ford Motor Company and Eaton for an F350 truck, which weighs roughly 5 tons. This system utilizes a reversible hydraulic pump/motor attached to a drive line that moves hydraulic fluid from a reservoir into a high-pressure accumulator during braking. During acceleration, the pressurized fluid is routed back through the pump/motor, which assists in the acceleration of the vehicle. However, the Ford system is simplistic in design and does not lend itself to smaller applications, such as compact-to-midsize electric and hybrid commuter vehicles.

### SUMMARY

It has been recognized that it would be advantageous to develop a new type of regenerative braking system for light and medium-weight vehicles that would recapture a higher percentage of the vehicle's kinetic energy during the braking process and then use the energy to accelerate the vehicle or, alternatively, to recharge the vehicle's battery pack.

In accordance with one aspect thereof, the invention provides a magnetic clutch, a continuously variable transmission, a hydraulic pump, a reservoir, a hydraulic accumulator, an electronically controlled valve manifold, a hydraulic motor and an electricity generator. The magnetic clutch is engaged when the vehicle operator indicates that he wants the vehicle to decelerate. The clutch transfers the rotation of the vehicle's wheels to the CVT. The CVT modulates RPM between the wheels and the hydraulic pump, bringing the pump up to maximum RPM gradually, thus preventing the vehicle from slowing too rapidly. As the pump moves hydraulic fluid from the reservoir to the accumulator and pressure begins to build in the accumulator, the pressure requires an increasing amount of energy to rotate the pump, which in turn causes the vehicle's wheels to reduce RPM, eventually, stopping the vehicle. Note that as the wheels begin to slow, the CVT continues to adjust gearing ratio so as to keep the pump operating at or near peak capacity as long as possible. When pressure in the accumulator reaches a sufficiently high level, a gate valve is opened, allowing the pressurized fluid to flow through a hydraulic motor, which turns a generator. The electricity created by the generator is used to replenish the vehicle's battery pack. Because pressure to the motor can be carefully regulated, electricity can be generated at the exact amperage necessary for optimal charging of the battery. Alternatively, the pressure from the accumulator could be routed back through the pumps, which would then become motors. Under this scenario, the pressure would be used to accelerate the vehicle.

To provide additional charging for the accumulator, electrical current could be fed into the generator, causing it to turn the hydraulic motor, which would cause the motor to begin to pump fluid, which could be routed into the accumulator via the gate valve. When the accumulator is full but kinetic energy continues to be available for recapture, fluid coming from the pumps can be routed directly to the motor/generator via the gate valve. The CVTs in the pump assemblies can be modulated to control the flow of fluid to the motor generator.

In accordance with another aspect thereof, the invention provides multiple pumps (as many as one for each of the vehicle's wheels) and multiple accumulators.

In accordance with another aspect thereof, the invention provides a magnetic clutch, a variable-displacement hydraulic pump, a reservoir, a hydraulic accumulator, an electronically controlled gate valve, a variable-displacement hydraulic motor, and a hydraulic motor and an electricity generator. The magnetic clutch is engaged when the vehicle operator indicates that he wants the vehicle to decelerate. The clutch transfers the rotation of the vehicle's wheels to the variable-displacement hydraulic pump. A control system modulates the displacement of the pump, bringing the volume per revolution up gradually during the braking process. The pump forces fluid into the accumulator. During acceleration, the fluid is routed back through the variable-displacement hydraulic motor. A control system modulates the displacement of the motor so as to bring the vehicle up to speed more easily. Note that in this configuration, the variable-displacement pump and motor act as hydrostatic transmissions in their respective roles. Alternatively, a reversible, variable-displacement pump/motor could be used.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein

FIG. 1 shows a top down view of the pumping/motive assembly.

FIG. 2 shows the pumping/motive assembly in relation to the fluid transfer and storage system

FIG. 3 shows an alternative embodiment of the invention utilizing a single pump/motor.

FIG. 4 shows another alternative embodiment of the invention utilizing variable-displacement hydraulic pump/motors.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

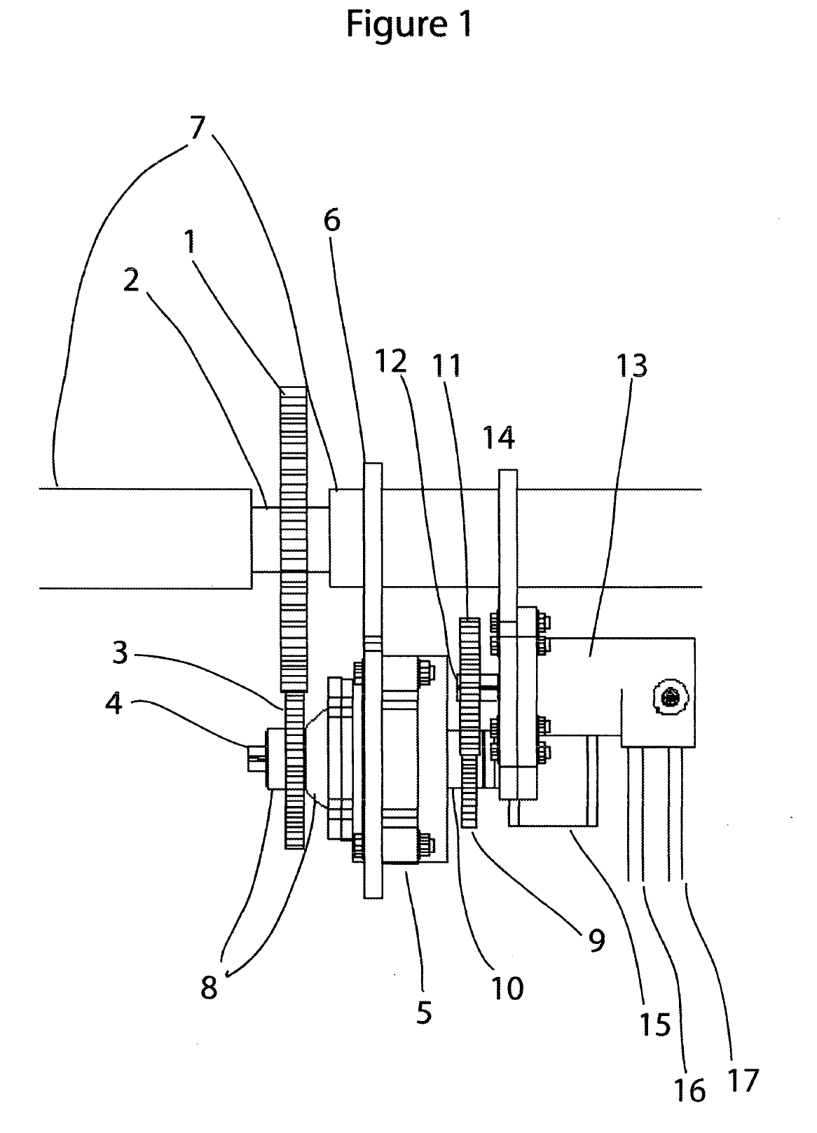

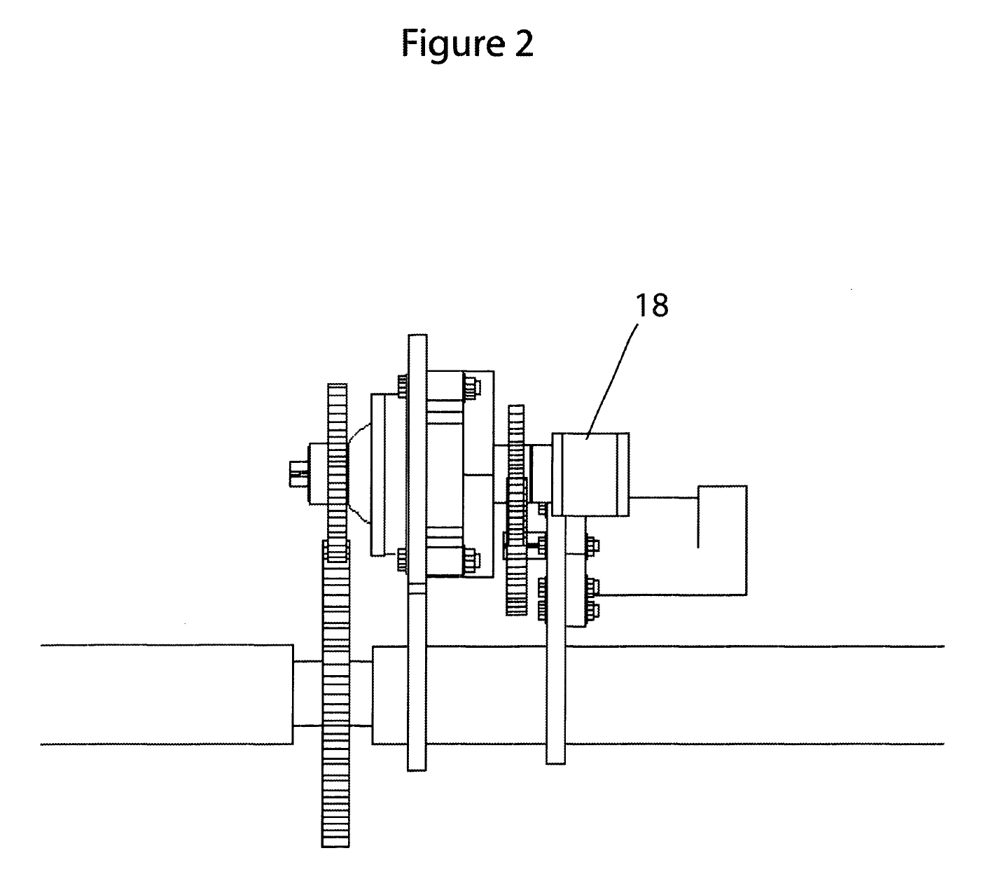

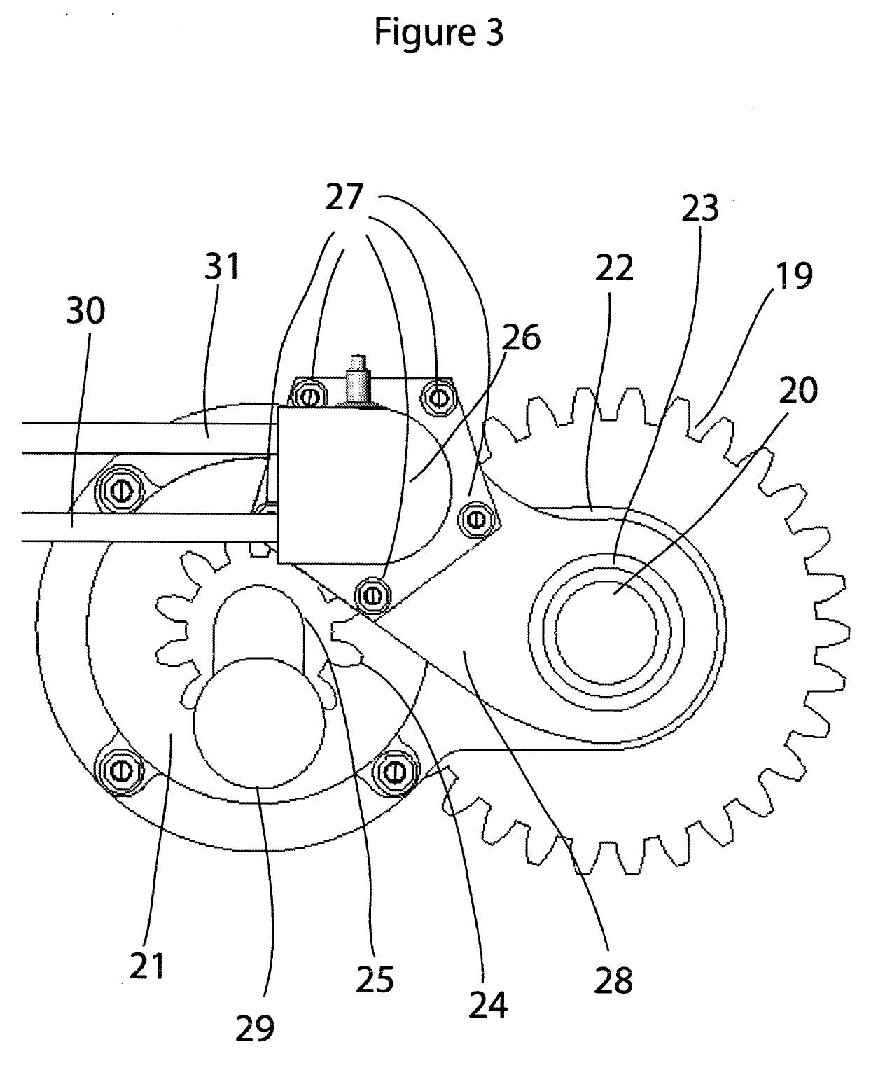

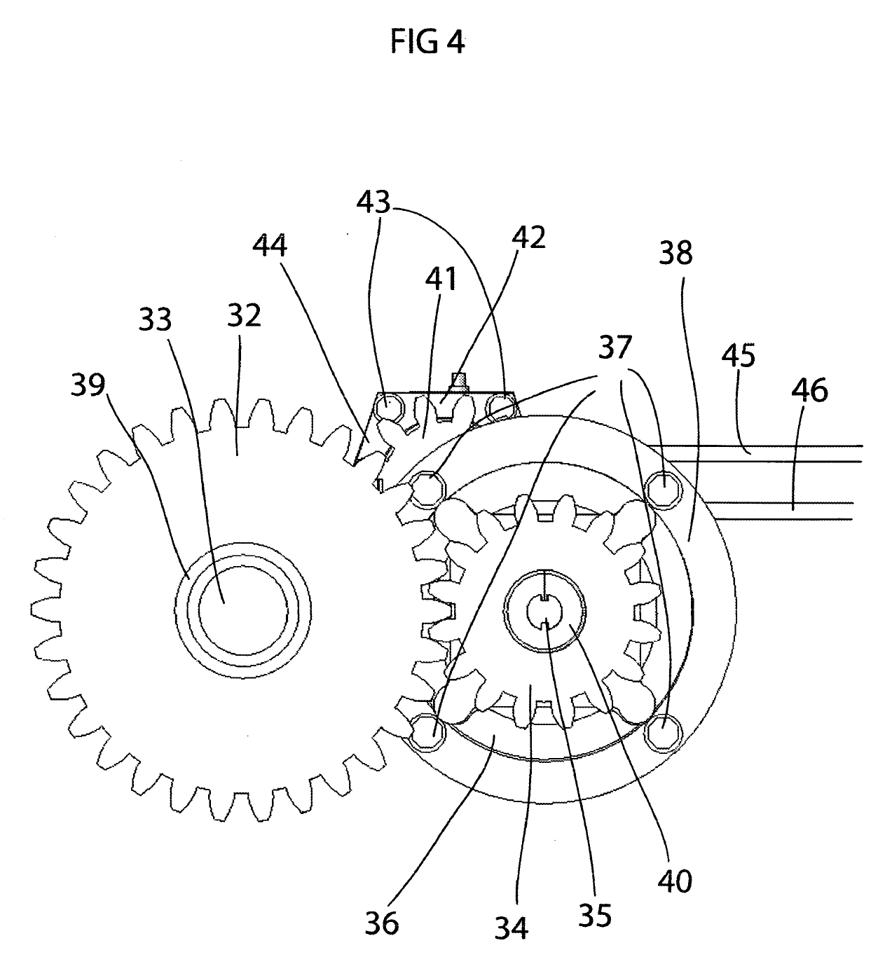

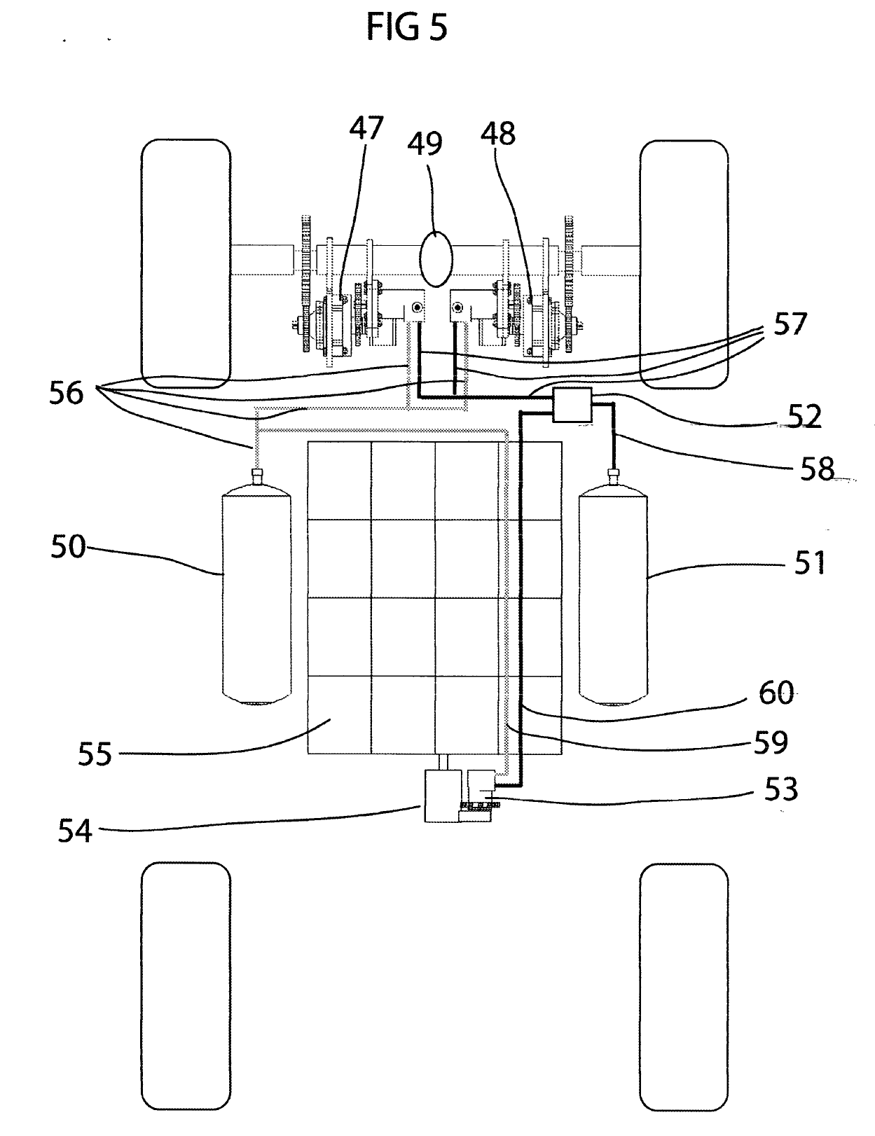

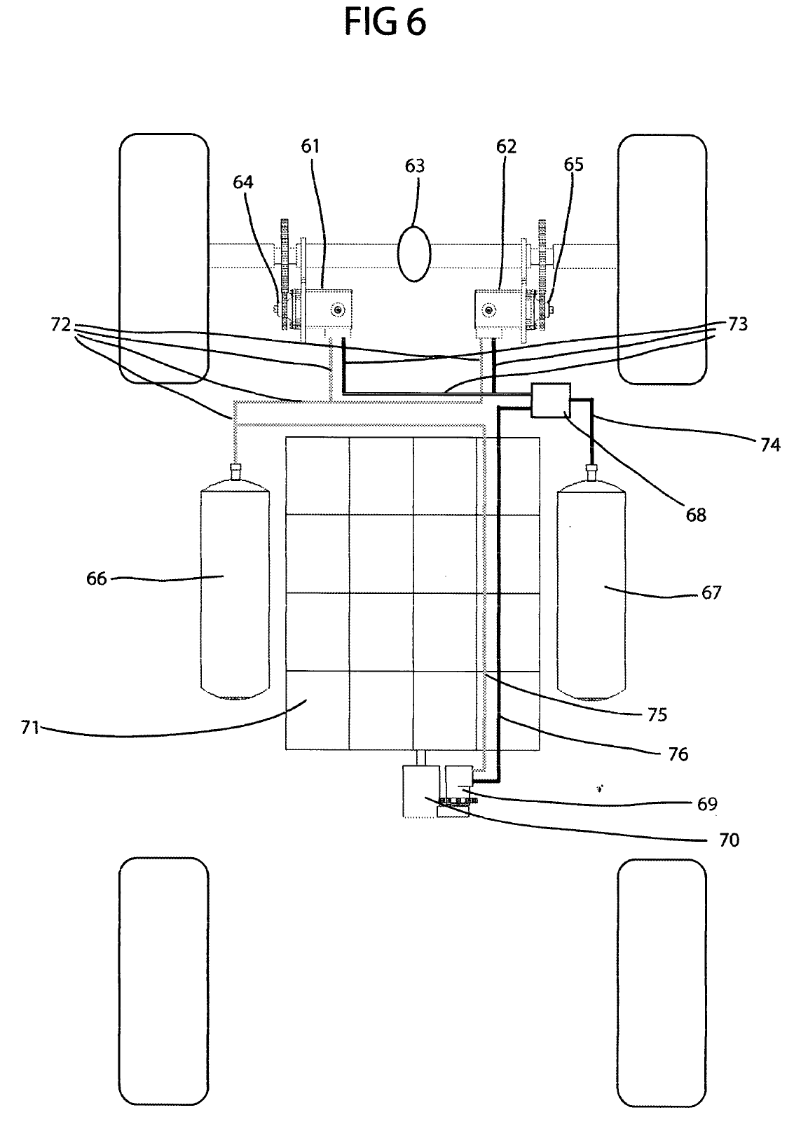

The invention advantageously utilizes hydraulic devices in combination with a transmission and generator to create a novel regenerative braking system which captures the vehicle's kinetic energy during the braking process and utilizes it to recharge the vehicle's battery or, alternatively to accelerate the vehicle.
FIG. 1 shows a top down view of the pumping assembly of the invention. A gear 1 is splined to an axle 2. (Note that the gear could be affixed to a drive shaft, or any other rotating part or assembly that is linked to the wheel(s) of the vehicle and which rotates in concert with the rotation of the wheel(s). Note also that a pulley could be used in place of a gear. Likewise, a beveled spur gear could be used on the axle or drive shaft to facilitate the use of a drive-shaft linkage between the axle and CVT.). Meshing with this gear is a second, free-spinning gear 3 on the input shaft 4 of a Continuously Variable Transmission 5 (CVT). Such transmissions are available from Fallbrook Technologies, of San Diego, Calif., or from Comet Industries of Richmond, Ind. (Note that almost any type of CVT will work in this assembly, including belt-and-pulley CVTs, traction-type CVTs, and hydraulic (hydrostatic) CVTs, so long as the CVT can be controlled by an external source. Geared transmissions may also be applied in this assembly, but with less efficiency. In some applications, the CVT may be removed from the assembly altogether. In this type of application, the rotation of the axle or drive shaft would be translated directly to a free-spinning gear on the hydraulic pump, which would be engaged by a magnetic clutch.) The CVT is held in place by a mounting bracket 6, which is splined to the axle sleeve 7. A magnetic clutch 8 resides on the shaft of the CVT. A gear 9 is splined to the output shaft 10 of the CVT. Meshing with this gear is a gear 11 splined to the shaft 12 of a reversible, hydraulic pump/motor 13. The hydraulic pump/motor is held in place by a mounting bracket 14, which is splined to the axle sleeve. An electric drive motor 15 is used to adjust the gearing ratio of the CVT. An hydraulic hose 16 supplies the pump/motor, and another hydraulic hose 17 routes liquid coming from the pump to a high pressure accumulator (not shown in this diagram).
During the braking—or slowing—process, the magnetic clutch is engaged via an electronic control system, causing the rotation of the axle or drive shaft, which is affixed to one or more of the vehicle's wheels, to be transferred to the input shaft of the CVT. The CVT modulates the RPM of the input gear with the RPM of the pump, which, upon engagement of the CVT, is at rest. This modulation prevents a rapid buildup in pressure in the hydraulic system from causing the vehicle to slow too rapidly. Based on input from the control system, the CVT will begin to change its gearing ratio. As the output RPM on the CVT begins to increase, pressure will begin to build in the system, causing the vehicle to decelerate. Based on the operator's pressure on the brake pedal, the CVT will continue to adjust. If the operator indicates that faster braking is required, the CVT will be adjusted to increase the RPM of its output shaft, which in turn will cause pressure to build more rapidly in the accumulator. Note that a redundant braking system is necessary for situations when the vehicle needs to be slowed more rapidly than pressure in the system can be accumulated.
FIG. 2 shows a bottom up view of the pumping assembly of the invention. Visible from the bottom view is the electric motor 18, which is used to adjust the gearing ratio of the CVT.
FIG. 3 shows a side view of the pumping assembly of the invention. A gear 19 is splined to an axle 20. A Continuously Variable Transmission 21 (CVT) is depicted. The CVT is held in place by a mounting bracket 22, which is splined to the axle sleeve 23. A gear 24 is splined to the output shaft 25 of the CVT. A hydraulic pump/motor 26 is depicted. The hydraulic pump/motor is bolted 27 to a mounting bracket 28, which is splined to the axle sleeve. An electric drive motor 29 is used to adjust the gearing ratio of the CVT. An hydraulic hose 30 supplies the pump/motor, and another hydraulic hose 31 routes liquid coming from the pump to a high pressure accumulator (not shown in this diagram).
FIG. 4 shows the opposing side view of the pumping assembly of the invention. A gear 32 is splined to an axle 33. Meshing with this gear is a second, free-spinning gear 34 on the input shaft 35 of a Continuously Variable Transmission 36 (CVT). The CVT is bolted 37 to a mounting bracket 38, which is splined to the axle sleeve 39. A magnetic clutch 40 resides on the shaft of the CVT. A gear is splined to the output shaft (not shown in this diagram) of the CVT. Meshing with this gear is a gear 41 splined to the shaft (not shown in this diagram) of a reversible, hydraulic pump/motor 42. The hydraulic pump/motor is bolted 43 to a mounting bracket 44, which is splined to the axle sleeve. An hydraulic hose 45 supplies the pump/motor, and another hydraulic hose 46 routes liquid coming from the pump to a high pressure accumulator (not shown in this diagram).
FIG. 5 shows a top down view of the entire invention. Dual pump assemblies 47, 48 are connected to a split front axle 49. A hydraulic reservoir 50 is used to supply hydraulic fluid to the pumps. An hydraulic accumulator 51 is used to collect and pressurize the hydraulic fluid from the pumps. An electronically controlled valve manifold 52 is used to route the pressurized fluid coming out of the accumulator. A hydraulic motor 53 is used to turn a generator 54, which in turn routes electrical current to the battery 55. (Note that the valve manifold is used to regulate pressurized fluid going to the motor/generator. This regulation is necessary since pressure in the accumulator will fluctuate constantly, particularly during city-driving situations. The valve will allow the hydraulic motor that drives the generator to maintain a relatively constant RPM, which will, in turn, allow the generator to produce a relatively constant current to the battery.) An enclosed network of hydraulic tubes 56 supplies liquid to the pumps. Another enclosed network of hydraulic tubes 57 routes fluid from the pumps to the accumulator. A hydraulic tube 58 serves as a conduit between the accumulator and the valve manifold. A hydraulic tube 59 routes fluid from the generator motor back to the reservoir. A hydraulic tube 60 is used to route fluid from the valve manifold to the generator motor.
The pump assemblies create suction in the system when engaged. Liquid is forced through the lines into the accumulators, where it becomes pressurized. During acceleration, the pressurized fluid can be routed back through pump/motors. Alternatively, the fluid can be routed to the generator. This methodology allows maximum utilization of the vehicle's kinetic energy. For example, in a braking situation where the accumulator was already at capacity, the hydraulic fluid could be routed directly to the generator. The rate of flow to the generator could be controlled by the gearing ratio of the CVT. Note that applying current to the electric generator would cause the generator to act as a motor, which in turn would cause the affixed hydraulic motor to become a pump. Utilizing the generator/motor in this way in combination with the valve manifold would force hydraulic fluid into the accumulator.
FIG. 6 shows another embodiment of the invention. Variable-displacement hydraulic pump mechanism 61,62 are affixed to a split drive axle 63 of the vehicle. Such pumps are available from Eaton, Parker, Rexroth and other manufacturers. Magnetic clutches 64,65 are used to engage the pumps during the braking process. Such clutches are regularly used in the air conditioning systems of automobiles, as well as other applications, and are available from multiple automobile component manufacturers. In most such pump's, displacement is adjusted internally by a mechanism controlled by an external circuit. A hydraulic reservoir 66 is used to supply hydraulic fluid to the pumps. An hydraulic accumulator 67 is used to collect and pressurize the hydraulic fluid from the pumps. An electronically controlled valve manifold 68 is used to route the pressurized fluid coming out of the accumulator. A hydraulic motor 69 is used to drive a generator 70, which in turn routes electrical current to the battery 71. (Note that the valve manifold is used to regulate pressurized fluid going to the motor/generator. This regulation is necessary since pressure in the accumulator will fluctuate constantly, particularly during city-driving situations. The valve will allow the hydraulic motor that drives the generator to maintain a relatively constant RPM, which will, in turn, allow the generator to produce a relatively constant current to the battery.) An enclosed network of hydraulic tubes 72 supplies liquid to the pumps. Another enclosed network of hydraulic tubes 73 routes fluid from the pumps to the accumulator. A hydraulic tube 74 serves as a conduit between the accumulator and the valve manifold. A hydraulic tube 75 routes fluid from the generator motor back to the reservoir. A hydraulic tube 76 is used to route fluid from the valve manifold to the generator motor. During the braking process, the magnetic clutches affixed to the pumps are engaged, causing the pumps to become engaged. Upon engagement of the pumps, the displacement of the pumps is determined digitally by the vehicle's mass as well as the rate at which the operator indicates that he/she wants the vehicle to decelerate. Upon its engagement, it can be assumed that the pumps' displacement would be very low, which would eliminate the possibility of a skid or of braking too rapidly. During the braking process, the displacement of the pumps would be gradually increased, thus maximizing the amount of fluid moved to the accumulator during the process. During the acceleration process, the valve manifold routes the pressurized liquid back through the variable-displacement/pumps/motors. Upon engagement of the magnetic clutches, the displacement of the motors would be low, allowing the motor to operate at high torque and low RPM. During the acceleration process, the displacement of the motors would be increased, causing the motors' torque to decrease and their RPM to increase.

By way of example, and without limitation, the invention can be described as a hydraulic braking system that captures an electric/hybrid vehicle's kinetic energy and utilizes it to assist in accelerating the vehicle or to recharge the vehicle's battery pack.

It is to be understood that the above-referenced arrangements are only illustrative of the application of the principles of the present invention in one or more particular applications. Numerous modifications and alternative arrangements in form, usage and details of implementation can be devised without the exercise of inventive faculty, and without departing from the principles, concepts, and scope of the invention as disclosed herein. Accordingly, it is not intended that the invention be limited, except as by claims that will be filed hereafter.

What is claimed is

1. A hydraulic regenerative braking system having a continuously variable transmission between the vehicle's drive train and a hydraulic pump/motor whereby the CVT can modulate RMP between the drive train and the hydraulic pump/motor, so as the motor can be brought up to speed gradually as the CVT is engaged.

2. In accordance with claim 1, a hydraulic regenerative braking system having a manifold between the hydraulic pump/motor and the hydraulic accumulator, the purpose of the manifold being to allow hydraulic fluid to enter the accumulator and upon the release of the fluid from the accumulator to route the fluid back through the hydraulic pump/motor for the purpose of accelerating the vehicle or alternatively routing the fluid through a hydraulic motor attached to an electric generator which would then use the stored hydraulic pressure for the purpose of recharging the vehicle's battery pack.
